(19) United States
(12) Patent Application Publication
(10) Pub. No.: US 2009/0028681 A1
(43) Pub. Date: Jan. 29, 2009

(54) APPARATUS FOR PICKING UP LENS

(75) Inventor: CHIEN-FENG HUANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/108,018

(22) Filed: Apr. 23, 2008

(30) Foreign Application Priority Data
Jul. 26, 2007 (CN) 200710201183.3

(51) Int. Cl. B25J 9/10

(52) U.S. Cl. 414/590

(57) ABSTRACT

An apparatus (20) for picking up a plurality of lenses at a time includes a robotic arm (22) including a rod (220) and a base plate (222) and a plurality of pipes (240). The rod is attached to the center of the base plate, and the lengthwise direction of the rod is perpendicular to the base plate. One end of each pipe includes a suction mouth (246) configured for picking up the lens. A pressure regulating valve (244) is coupled to each of the pipes to adjust a pressure adjustment in the respective pipe. Each of the pressure regulating valves is attached to a periphery of the base plate respectively.

### BACKGROUND

1. Field of the Invention

The present invention relates to apparatuses for picking up lens, and particularly, to an apparatus for picking up lenses after being molded by multi-cavity molds.

2. Description of Related Art

With the development of the optical imaging technology, camera devices, such as digital cameras and mobile phones, are widely used electronic devices. Optical elements (e.g., lenses) are one of the most critical components in any camera device.

Most optical lenses are typically made in an injection molding process which utilizes a single cavity mold. Although single cavity molds typically provide the best uniformity in the optical lenses, they have the deficiency of rather inefficient productivity. That is, only a single optical lens may be formed at one time. The molding of each lens is necessarily separated by the steps of opening the mold, ejecting the molded object, closing the mold, and repeating the process. Clearly, multi-cavity molding would provide greater efficiency because multiple lenses could be molded in a single step.

Generally, an apparatus utilized for picking up lenses being molded by multi-cavity molds can only pick up one lens at a time.

Therefore, what is needed is an apparatus for picking up lenses with higher efficiency.

### SUMMARY

An apparatus for picking up a plurality of lenses at a time includes a robotic arm including a rod, a base plate and a plurality of pipes. The rod is attached to the center of the base plate, and the lengthwise direction of the rod is perpendicular to the base plate. One end of each pipe includes a suction mouth configured for picking up the lens. A pressure regulating valve is coupled to each of the pipes to adjust air pressure in the respective pipe. Each of the pressure regulating valves is attached to a periphery of the base plate respectively.

### BRIEF DESCRIPTION OF THE DRAWINGS

Many aspects of the present apparatus can be better understood with reference to the following drawings. The components in the drawings are not necessarily drawn to scale, the emphasis instead being placed upon clearly illustrating the principles of the present apparatus. Moreover, in the drawings, like reference numerals designate corresponding parts throughout the several views.

FIG. 1 is a schematic, isometric view of an apparatus for picking up lens in accordance with a first embodiment.

FIGS. 2 to 3 illustrate the process of a method for picking up lenses using the apparatus shown in FIG. 1.

FIG. 4 is a schematic, isometric view of an apparatus for picking up lens in accordance with a second embodiment.

FIGS. 5 to 7 illustrate the process of a method for picking up lenses using the apparatus shown in FIG. 4.

### DETAILED DESCRIPTION OF THE INVENTION

Reference will now be made to the drawings to describe in detail the preferred embodiments of the present apparatus for picking up lenses after being molded by multi-cavity molds.

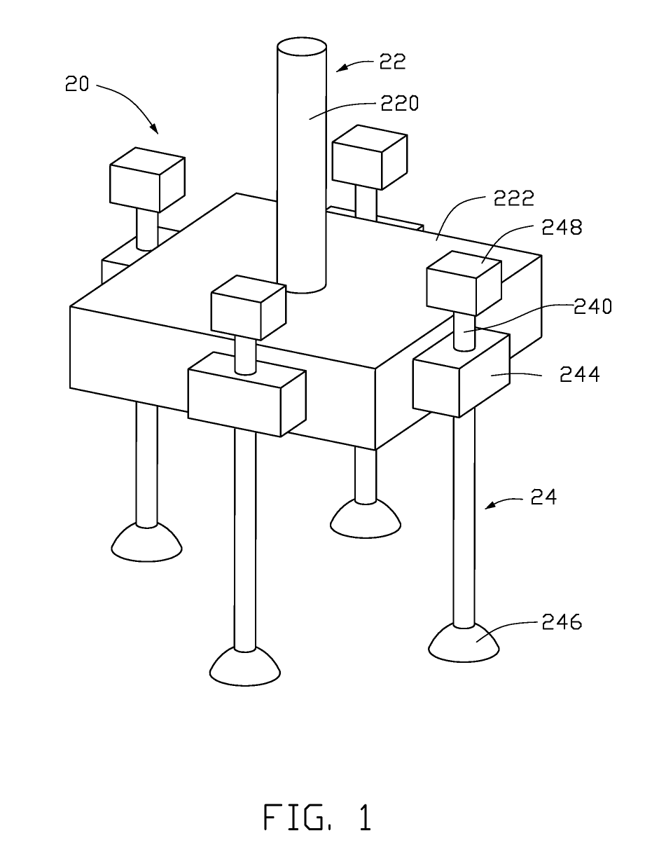

Referring to FIG. 1, an apparatus 20 for picking up lenses, according to a first present embodiment, includes a robotic arm 22 and four pick-up devices 24.

The robotic arm 22 includes a rod 220 and a base plate 222. In the present embodiment, the base plate 222 is substantially cubic shaped. In alternative embodiments, the base plate 222 also can be cylinder shaped. The rod 220 is attached to the center of the base plate 222. The lengthwise direction of the rod 220 is perpendicular to a surface of the base plate 222.

Each of the pick-up devices 24 includes a pipe 240. The pipe 240 has two ends. One end of the pipe 240 includes a suction mouth 246. The suction mouth 246 is substantially bowl shaped. The other end of the pipe 240 is connected to a vacuum pump 248 configured for providing suction at the suction mouth 246. A pressure regulating valve 244 is coupled to the pipe 240 to adjust air pressure in the respective pipe 240.

The pipes 240 are rigid pipes. A material of the pipe 240 can be selected from the group consisting of ferrum, stainless steel, and plastic. A material of the suction mouth 246 can be rubber or plastic. The suction mouth 246 can be disassembled from the pipe 240.

In the present embodiment, the pressure regulating valve 244 of each of the pick-up devices 24 is attached to a sidewall of the base plate 222 respectively. The pipes 240 of the four pick-up devices 24 are parallel to each other. The lengthwise direction of each of the pipes 240 is perpendicular to the base plate 222. In operation, the suction mouth 246 of each of the pick-up devices faces each of the lenses waiting to be picked up. It is understood that, the size of the base plate 222 and the distance between the pick-up devices 24 can be adjusted according to the needs of the multi-cavity molding.

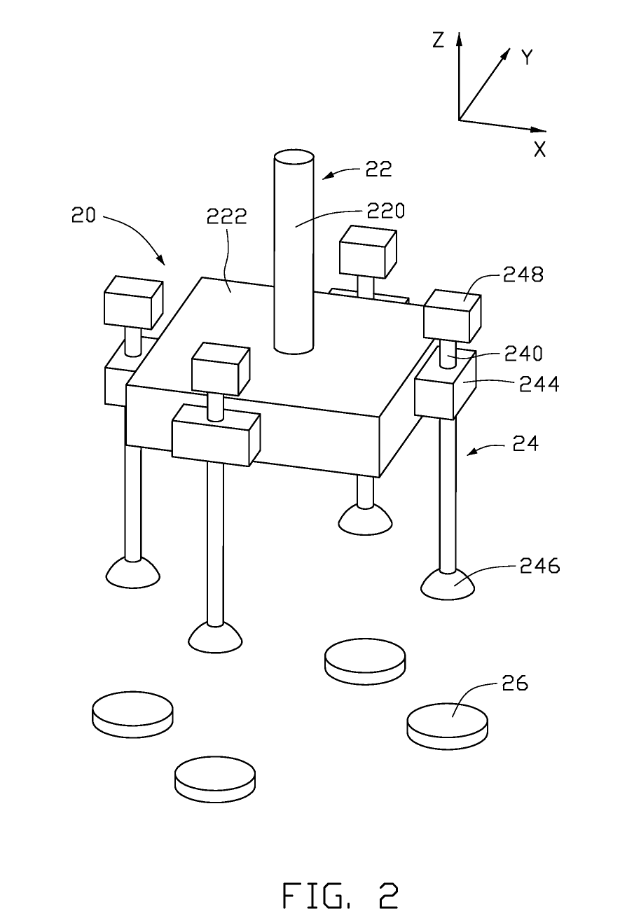

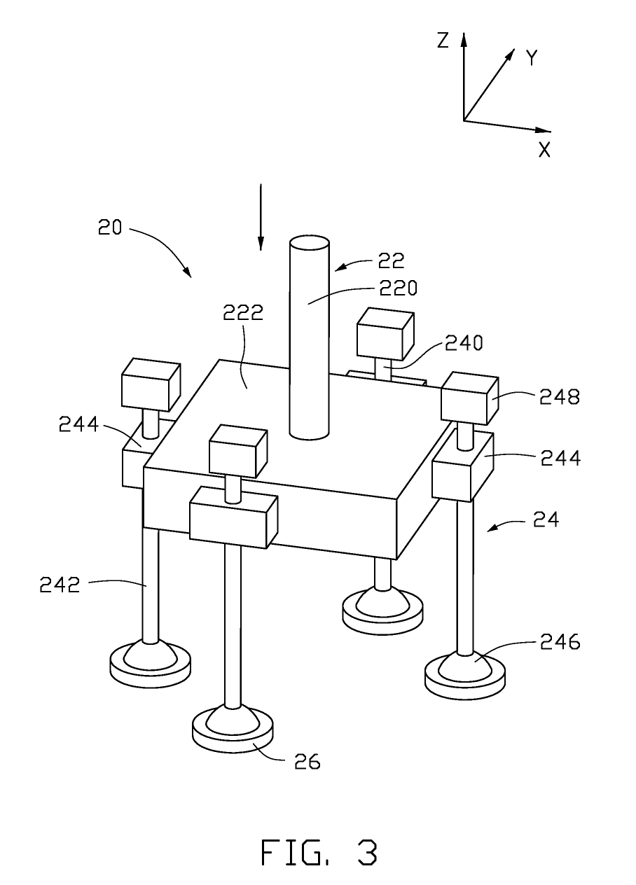

Referring to FIGS. 2 to 3, process of a method for picking up the lenses using the apparatus in the first embodiment is illustrated.

In step 1, the prefabricated lenses 26 are molded by a four-cavity mold. The lenses 26 are cut off from the stub bars by a shearing device (this step is not shown in the figures).

In step 2, the position of the robotic arm 22 is adjusted, so that each of the suction mouths 246 directly faces each of the lenses 26 (referring to FIG. 2).

In step 3, referring to FIG. 3, the robotic arm 22 is moved toward the lenses 26. The pressure regulating valves 244 are opened, and a vacuum pump 248 connected with the pipe 240 is used to provide suction at the suction mouth 246. The lenses 26 are picked up by the suction mouths 246. Then, the pressure regulating valves 244 are closed.

In step 4, the robotic arm 22 is moved to a predetermined position to release the picked up lenses 26 in a case, such as a lens tray.

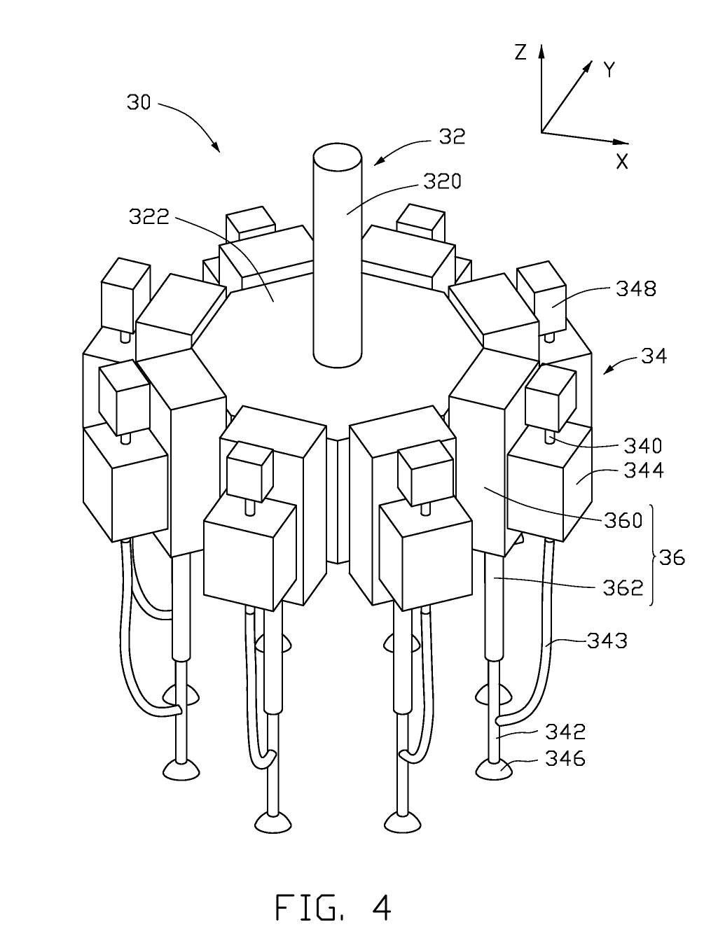

Referring to FIG. 4, an apparatus 30 for picking up lens in eight-cavity molding procedures is illustrated. The apparatus 30 includes a robotic arm 32 and eight pneumatic cylinders 36.

The robotic arm 32 includes a rod 320 and a base plate 322. In the present embodiment, the base plate 322 is substantially eight prismatic shaped. In alternative embodiments, the base plate 322 also can be cylinder shaped. The rod 320 is attached to the center of the base plate 322. The lengthwise direction of the rod 320 is perpendicular to a surface of the base plate 322.

Each of the pneumatic cylinders 36 has a cylinder tube 360, a piston (not shown), and a shaft 362 slidably relative to the cylinder tube 360. The shaft 362 is connected with the piston inside the pneumatic cylinder 36. Each of the pneumatic cylinders 36 is attached to a sidewall of the base plate 322 respectively.

Each of the pick-up devices 34 includes an rigid pipe 340 and a pick-up pipe 342. The rigid pipe 340 and the pick-up pipe 342 respectively have two ends. One end of the rigid pipe 340 is connected to and in communication with the pick-up pipe 342 by a flexible pipe 343. One end of the pick-up pipe 342 is attached to the shaft 362. The other end of the pick-up pipe 342 includes a suction mouth 346. The suction mouth 346 is substantially bowl shaped. The other end of the rigid pipe 340 is connected to a vacuum pump 348 configured for providing suction at the suction mouth 346, so that the lens can be sucked by the suction mouth 346. A pressure regulating valve 344 is coupled to the rigid pipe 340 to adjust air pressure in the rigid pipe 340.

A material of the pick-up pipe 342 can be selected from the group consisting of ferrum, stainless steel, and plastic. A material of the suction mouth 346 can be rubber or plastic. The suction mouth 346 can be disassembled from the pick-up rigid pipe 340.

In the present embodiment, the pressure regulating valve 344 of each of the pick-up devices 34 is attached to each of the pneumatic cylinder 36 respectively. The pick-up pipes 340 of the eight pick-up devices 34 are parallel to each other. The lengthwise direction of the pick-up pipes 340 is perpendicular to the base plate 322. In operation, the suction mouth 346 of each of the pick-up devices 34 faces each of the lenses waiting to be picked up. It is understood that, the size of the base plate 322, the number of the pick-up devices 34, and the distance between the pick-up devices 34 can be adjusted according to the needs of the multi-cavity mold.

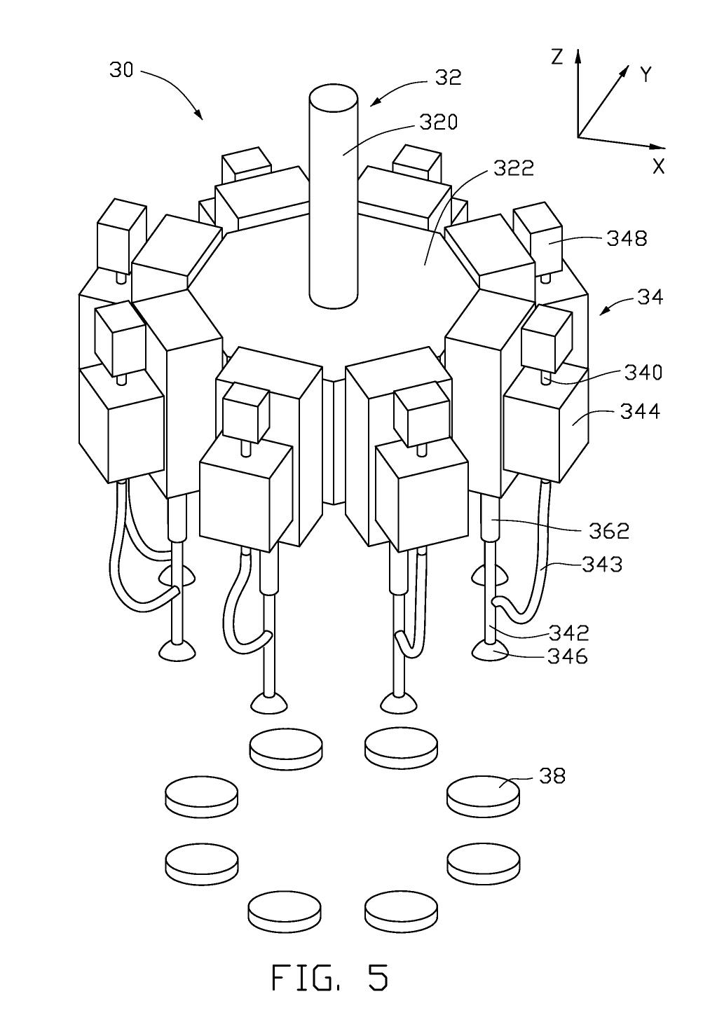

Referring to FIGS. 5 to 7, process of a method for picking up the lenses using the apparatus in the second embodiment are illustrated partially.

In step 1, the prefabricated lenses are molded by a eight-cavity mold. The lenses 38 are cut off from the stub bars by a shearing device (this step is not shown in the figures).

In step 2, the position of the robotic arm 32 is adjusted, so that each of the suction mouths 346 faces each of the lenses 38 (referring to FIG. 5).

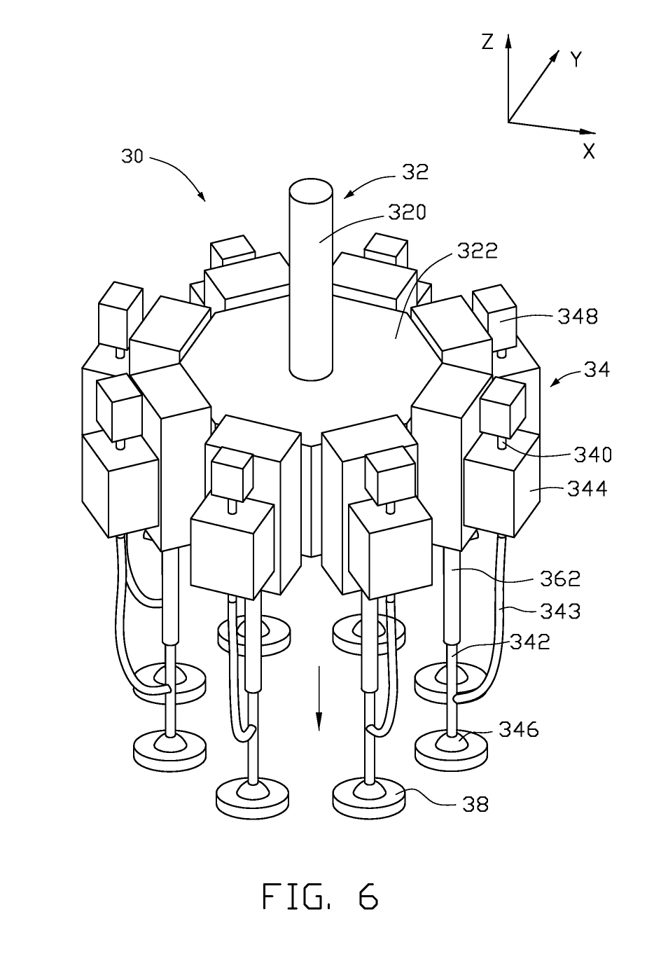

In step 3, referring to FIG. 6, the connecting rod 342 is driven by the pneumatic cylinder 36 to move towards the lenses 38. The pressure regulating valves 344 are opened, and a vacuum pump 348 connected with the rigid pipe 340 provides suction at the suction mouth 346. The lenses 38 are sucked up by the suction mouths 346. The pressure regulating valves 344 are closed.

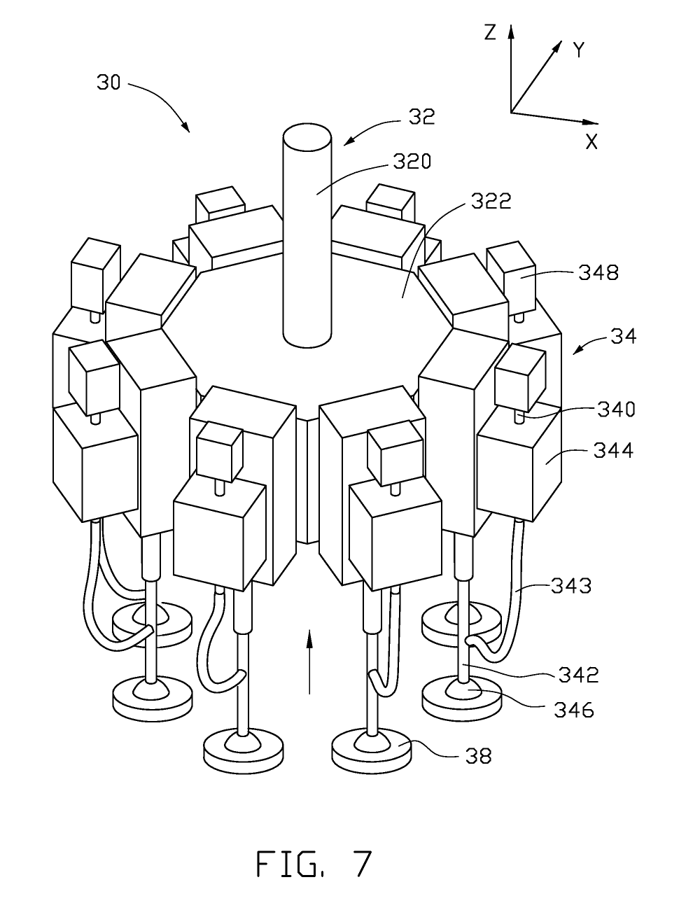

In step 4, referring to FIG. 7, the connecting rod 342 is driven by the pneumatic cylinder 36 to retract. The robotic arm 32 is then moved to a predetermined position to release the lenses 38 in a case, such as a lens tray.

Compared with the conventional apparatus for picking up lenses, the apparatus 10, 30 can provide significant cost and time savings when the lenses are molded by multi-cavity molding.

While the present invention has been described as having preferred or exemplary embodiments, the embodiments can be further modified within the spirit and scope of this disclosure. This application is therefore intended to cover any variations, uses, or adaptations of the embodiments using the general principles of the invention as claimed. Furthermore, this application is intended to cover such departures from the present disclosure as come within known or customary practice in the art to which the invention pertains and which fall within the limits of the appended claims or equivalents thereof.

What is claimed is:

1. An apparatus for picking up a plurality of lenses at a time, comprising:
a robotic arm including a rod and a base plate, wherein the rod is attached to the center of the base plate, the lengthwise direction of the rod is perpendicular to the base plate;
a plurality of pipes, one end of each pipe comprising a suction mouth configured for picking up the lens; and
a pressure regulating valve coupled to each of the pipes to adjust a pressure in the respective pipe, wherein the pressure regulating valves is attached to a periphery of the base plate.

2. The apparatus as described in claim 1, wherein the base plate is cylinder shaped or prismatic shaped.

3. The apparatus as described in claim 1, further comprising a vacuum pump, wherein the other end of each pipe is connected with the vacuum pump.

4. The apparatus as described in claim 1, wherein the suction mouth is bowl-shaped.

5. The apparatus as described in claim 1, wherein the pipes are rigid pipes.

6. The apparatus as described in claim 1, wherein a material of the suction mouth is rubber or plastic.

7. The apparatus as described in claim 5, wherein the pipes are parallel to each other.

8. The apparatus as described in claim 7, wherein the lengthwise direction of each of the pipes is perpendicular to the base plate.

9. An apparatus for picking up a plurality of lenses at a time, comprising:
a robotic arm including a rod and a base plate, wherein the rod attached to the center of the base plate, the lengthwise direction of the rod is perpendicular to the base plate;
a plurality of pneumatic cylinders, each of the pneumatic cylinders having a cylinder tube, a piston, a shaft slidably relative to the cylinder tube, wherein each of the pneumatic cylinders is attached to a periphery of the base plate;
a plurality of rigid pipes;
a plurality of flexible pipes;
a plurality of pick-up pipes, one end of each of the rigid pipes being connected to and in communication with the pick-up pipe through the flexible pipe, one end of each of the pick-up pipes being connected to the shaft, the other end of each of the pick-up pipes comprising a suction mouth configured for picking up the lens; and
a pressure regulating valve coupled to each of the rigid pipes to adjust a pressure in the rigid pipe.

10. The apparatus as described in claim 9, wherein the base plate is cylinder shaped or prismatic shaped.

11. The apparatus as described in claim 9, further comprising a vacuum pump, wherein the other end of each rigid pipe is connected with the vacuum pump.

12. The apparatus as described in claim 9, wherein the suction mouth is bowl-shaped.

13. The apparatus as described in claim 9, wherein a material of the pick-up pipe is selected from the group consisting of ferrum, stainless steel, and plastic.

14. The apparatus as described in claim 9, wherein a material of the suction mouth is rubber or plastic.

15. The apparatus as described in claim 13, wherein the pick-up pipes are parallel to each other.

16. The apparatus as described in claim 15, wherein the lengthwise direction of each of the pick-up pipes is perpendicular to the base plate.

17. An apparatus for picking up a plurality of lenses, comprising:
a base support;
a lens picking device; and
an articulated arm assembly interconnecting the base support and the lens picking device;
where the lens picking device including
a mounting member,
a rod having a first end coupled to the articulated arm and an opposite second end mounted to the mounted member,
a plurality of pipes associated with a periphery of the mounting member, each of the pipe having a first end for connection to a vacuum pump and an opposite second end with a suction mouth configured for picking up a lens; and
a plurality of pressure regulating valves coupled to the respective pipes for adjusting a pressure in the pipe.
